(19) United States
(12) Patent Application Publication
(10) Pub. No.: US 2002/0130779 A1
(43) Pub. Date: Sep. 19, 2002

(54) Intensive care calculator

(76) Inventor: Herbert Ford, (US)

Correspondence Address: Herbert Ford, 4321 Woods Drive, Oklahoma City, OK, 73111, US

(21) Appl. No.: 09/805,278

(22) Filed: Mar. 13, 2001

(51) Int. Cl. G08B 23/00

(52) U.S. Cl. 340/573.1; 128/920; 340/540

(57) ABSTRACT

Computer-calculator means are provided for calculating the appropriate dosage for intravenously administered therapeutic agents commonly used in emergency care situations for human patients. Alarm means are incorporated within the computer-calculator to advise and warn of improper data input which might result in an improper dosage and cause harm to a patient.

### BACKGROUND OF THE INVENTION

1. Field of the Invention

This invention relates generally to intravenous drug administration and, more particularly, but not by way of limitation, to a device incorporating software for accurate calculation of dosage rates for commonly prescribed drugs applicable to critical care situations, such as emergency rooms and intensive care units.

2. Background of the Invention

Intravenous drugs are commonly infused in critical care situations, such as in the event of myocardial infarction where cardioresuscitative drugs are necessary and appropriate means of treatment. Such drugs are, generally, isoproterenol, lidocaine hydrochloride, bretylium tosylate, procanamide hydrochloride, phenylephrine hydrochloride, sodium nitropusside, dilitiazem hydrochloride, dobutamine hydrochloride, dopamine hydrochloride, norepincphrine, heparin sodium, insulin regular, adrenaline, lidocaine and nitroglycerine. The safe and efficacious intravenous administration of such drugs is often dependent upon the weight of the patient. Conversely, many commonly used intravenous drugs are not dependent upon accurate calculation of the weight of the patient in determining safe and efficacious administration. Each drug infusion rate calculation is therefore dependent or not dependent, as the case may be, upon the criticality of the patient's weight. Conventionally, medical personnel are required to recall the formulas applicable to each category of drug, to determine the weight of the patient, where necessary, and to manually calculate proper dosage i.e. drip rate based upon the parameters prescribed by the attending physician, the drug prescribed, volume of intravenous fluid, and other critical parameters. A particular problem which arises with manual calculations is that, quite often, medical personnel in critical care situations are operating under a stressful environment and speed in infusing the patient is of the essence in achieving a satisfactory outcome for the patient. An example of the common method of determining drip rates is expressed in the following equation:

D×BW×60=C×R

The variables for this equation are defined as follows:

D=Dosage Rate expressed in units per kilogram per minute (ug/kg/min)

BW=Body Weight expressed in kilograms (kg)

C=Concentration of infusion expressed in units per milliliter (ug/ml)

R=Rate of infusion expressed in milliliters per hour (ml/hr)

(Constant=60 minutes per hour)

The representative equation includes five variables requiring that a series of calculations be performed each time a drug is prepared and used. Medical personnel are often required to rely upon their memory to recall safe dose ranges for drugs being administered by them and, often, medical personnel are required to manually perform the entire sequence of calculations, relying on the knowledge of the prescribing physician as to safe drug dose ranges. Further, drugs are often administered simultaneously to a given patient. Some drugs are not compatible for infusion via a common intravenous tube and must, if to be administered safely and simultaneously, be infused at different points of the body of the patient. Medical personnel are often required to commit to memory the compatibility status of drugs thusly endangering the welfare of the patient.

Prior art devices used to assist medical personnel in the proper dosage calculations disclose calculators adapted to various specific uses but none that can reliably provide the specific information of the present invention. Examples of prior art devices are disclosed in Barkett et al. U.S. Pat. No. 4,709,331 presenting a calculator for medical personnel to convert quantitative values from one system to another. U.S. Pat. No. 4,807,170 issued to Kulli et al. discloses a drug dosage calculator.

### SUMMARY OF THE INVENTION

In accordance with the present invention, a computer-calculator has been developed which automates the calculation of infusion rates of common intravenous drugs in a rapid and reliable manner thus essentially eliminating the potential for human error in the calculation of dosage and drip rate. Alarms are encoded within the computer-calculator means to alert the operator that >parameters of safe administration are violated but such alarms may be overridden when the situation warrants. Further, means are provided to display potential adverse drug interactions.

Other objects and advantages of the present invention will become readily apparent to those skilled in the art by a reading of the following detailed description of the invention and the claims.

### BRIEF DESCRIPTION OF THE DRAWING

FIG. 1 illustrates a keyboard and display arrangement that may be included in the invention.

Attached as Exhibit A hereto is a flow chart of the infusion rate calculation subroutines of the invention.

### DETAILED DESCRIPTION OF PREFERRED EMBODIMENTS OF THE INVENTION

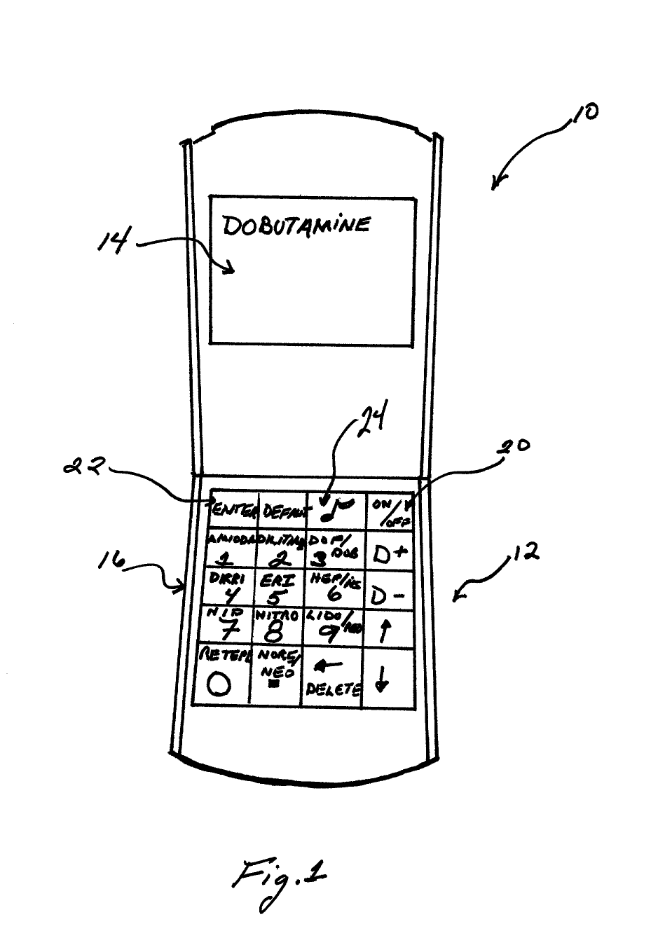

Referring to the FIGURE of the drawing, a calculator is disclosed which has a conventional hand sized computer power supply, an on/off switch 20 and an enter key 22. In FIG. 1, the calculator, generally indicated 10 includes a keyboard 12 and display 14 mounted in a case 16. The keyboard 12 and display 14 are connected to a microcomputer 16 (not shown). The keyboard 12 supplies inputs to the microcomputer 16. The microcomputer 16 supplies provides outputs to a display 14. The display 14 and microcomputer 16 receive power from a conventional batter power supply 18 (not shown) which preferably contains a low voltage warning signal if the voltage drops below a predetermined value and automatically turn the power supply 18 off after it has been on for a predetermined period of time. The microcomputer 16 is further connected to an audible warning buzzer 24 for the purpose of audibly informing a user that a predetermined parameter has been exceeded. The display 14 is preferably a multiplex LED display, which is well known in the art.

Operation of the calculator is initiated by turning on the start switch 20 to start the microcomputer 16 and light the display 14. The display 14 displays a drop down list of drugs and an entry line which directs the user to SELECT DRUG. The user scrolls the drug list to locate the appropriate drug and presses the ENTER key 22. Pressing the ENTER key 22 when the appropriate drug is highlighted initiates a series of questions from the microprocessor 16 which are displayed on the display 14 regarding the numerical parameters appropriate to the specific drug selected by the user. For example, if the drug insulin is selected by the user by pressing the ENTER key 22 when insulin is highlighted on the SELECT DRUG list, the microcomputer 16 then prompts the user to enter the desired numerical value for the DRIP RATE, normally a value of 60. The user inputs the preferred drip rate and, if the drip rate is within normal limits, the microcomputer 16 accepts the input, displays the drip rate input on the screen and proceeds to the next parameter question which, in the case of insulin, is the concentration. In the event a user inputs a drip rate which exceeds the normal parameters, either higher or lower than recommended, the display 14 will flash, the alarm 24 will sound, and the microcomputer 16 will not proceed with the calculation until an acceptable 5 input is received from the user. Proceeding with the entry of numerical parameters, the microcomputer 16 causes the display 14 to present the user with the question “CONCENTRATION _?” in a flashing manner. The microcomputer 16 also displays the efficacious high and low parameters for insulin concentrations on the display 14. The user must input a concentration of the drug in units per milliliter. Again, if the user inputs an unacceptable number, the microcomputer halts the sequence and flashes the display 14 and sounds the alarm 24 to notify the user that an unacceptable parameter has been entered. Upon entry of an acceptable concentration, the microprocessor then prompts the display to flash a third inquiry to the user to input the “FLUID VOLUME_?” while displaying the efficacious high and low parameters for fluid volume. The user inputs the volume of infusion fluid. The microprocessor then prompts the user to input the “DOSAGE _” per the physician's order while displaying the efficacious high and low parameters for normal dosage range. Upon entry of this numerical input, the microprocessor then displays the correct infusion rate and further displays a scrollable list of incompatible drugs.

In operation of the preferred embodiment, the operator presses the on/off key 20. The display 14 displays the scroll down menu of drugs. The user selects a drug from the predetermined list of commonly utilized intravenous drugs. Upon selection of a predetermined drug, such as dobutamine, the calculator 16 selects the appropriate formula and applicable alarm parameters and requests the operator to first input the prescribed drip rate in units per hour. Upon input of a dosage which does not exceed the alarm parameters, the calculator 16 then requests the operator to input the concentration of dobutamine expressed in units per millilitcr. The microcomputer 16 then prompts the user to input the fluid volume. The microcomputer 16 then prompts the user to input the dosage.

The microcomputer 16 then prompts the user to input the weight of the patient. Ifthe requested input regarding the patient's weight is accepted, the calculator 16 then displays 14 the appropriate infusion (drip) rate. In the event, and upon the event of each input in the progression, the operator inputs a response which exceeds the pre-programmed alarm parameter applicable to that specific data input, the calculator 16 will not proceed to the next inquiry but the display 14 will flash to signal the operator that a preprogrammed parameter has been exceeded as well as display the input data which exceeded the alarm parameter and invite the operator to replace the apparently erroneous input. The operator may then re-input the requested information. If the alarm parameter is again exceeded, the display 14 will again flash to signal an apparent erroneous input. The operator then has the option of entering data which comports and falls within the alarm parameters. In the event corrective input is not received, the calculator will continue to flash its display and refuses to proceed further with the calculation in the absence of an appropriate input.

It will be understood that the operational sequence described above is accomplished by programming the microprocessor 16 in accordance with programming principles which are well known in the art to produce that sequence. The attachment, Exhibit A hereto depicts the general structure of a computer program to perform the functions in the sequences herein described.

Although the invention has been described with reference to a specific preferred embodiment, it should be understood that modifications may be made to the preferred embodiment without departing from the spirit of the invention. Accordingly, the invention encompasses the subject matter of the following claims, which distinctly point out the inventions, and equivalents thereof.

What is claimed is:

1. A calculator-computer comprised of conventional numerical keys, function keys, an on/off switch, a power source, display and memory registers in combination with program means for selecting an intravenous drug from a predetermined list of drugs stored in said memory registers, inputting choice of drip rate, inputting the known variable of drug concentration in milligrams, inputting the known variable of fluid volume in milliliters, inputting the known variable of patient weight in kilograms, alarm means for disabling the display means when preprogrammed parameters are exceeded, and display means for obtaining results from said program means and for displaying a list of compatible and incompatible intravenous drugs in response to the selection of a drug from the predetermined list of drugs stored in memory registers.

2. The combination of claim 1 in which said alarm means are activated by said program means when an input data variable deviates from a predetermined input data variable parameter.

3. The combination of claim 1 wherein the predetermined list of drugs stored in said memory registers are dobutamine, dopamine, nitroprusside, epinephrine, isoproterenol, nitroglycerin. norepinephrine, bretylium, lidocaine, procainamide, heparin, insulin and amiodarone.
